(19) United States
(12) Patent Application Publication
(10) Pub. No.: US 2007/0264942 A1
(43) Pub. Date: Nov. 15, 2007

(54) RF TRANSCEIVER AND COMMUNICATION DEVICE USING THE SAME

(75) Inventor: Min-Chuan Wu, Taichung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: MEDIATEK INC., Hsin-Chu (TW)

(21) Appl. No.: 11/681,824

(22) Filed: Mar. 5, 2007

Related U.S. Application Data
(60) Provisional application No. 60/747,207, filed on May 15, 2006.
(60) Provisional application No. 60/806,279, filed on Jun. 30, 2006.

(51) Int. Cl. H04B 1/38

(52) U.S. Cl. 455/73

(57) ABSTRACT

An RF transceiver. The RF transceiver comprises a temperature sensor and a first variable gain amplifier (VGA). The temperature sensor has an input node receiving an input voltage from a base band processor and an output node providing an output voltage. The first VGA is coupled to the first temperature sensor wherein a gain thereof is controlled by the output voltage.

### BACKGROUND OF THE INVENTION

1. Field of the Invention

The invention relates to an RF transceiver and, in particular, to an RF transceiver with a temperature sensor.

2. Description of the Related Art

In wireless communication, radio frequency integrated circuits (RFICs) are used in cellular phones, communication devices and the like. An RF transceiver is an indispensable element in an RFIC.

FIG. 1 is a block diagram of system architecture of a conventional transmitter used in a communication device. The conventional transmitter comprises a first local oscillator (LO) 101, first mixers 103 and 103′, an intermediate frequency variable gain amplifier (IF VGA) 105, a second LO 107, a second mixer 109, a surface acoustic wave (SAW) filter 111, a power amplifier (PA) 113, an isolator 115, and an antenna 117. The first LO 101 provides a first local clock to the first mixers 103 and 103′ which up-convert base band signals I and Q to intermediate frequency band according thereto. Up-converted signals are combined as an intermediate frequency (IF) signal. The IF VGA 105 receives and amplifies the IF signal. The second mixer 109 up-converts the amplified IF signal to a radio frequency (RF) signal according to a second clock generated by the second LO 107. Subsequently, the RF signal is filtered by the SAW filter 111 and amplified by the power amplifier 113. The amplified RF signal is received by the isolator 115 and then transmitted by the antenna 117.

For GSM EDGE, 8 phase-shift keying (8PSK) modulation is required. Each symbol in 8PSK modulation comprises data of 3 bits. Phase and amplitude of the data need to be kept intact such that information therein is not lost. When the conventional transmitter operates under low temperature conditions, amplifiers therein typically have higher gain due to characterization drift of devices. As a result, output signal transmitted by the PA 113 may be saturated and amplitude of the data thus distorted. Due to signal distortion, information in the transmitted signal is lost and the conventional transmitter cannot work properly under low temperature.

### BRIEF SUMMARY OF THE INVENTION

An embodiment of an RF transceiver comprises a temperature sensor and a first variable gain amplifier (VGA). The temperature sensor has an input node receiving an input voltage from a base band processor and an output node providing an output voltage. The first VGA is coupled to the first temperature sensor wherein a gain thereof is controlled by the output voltage.

The invention provides an RF transceiver with a temperature sensor coupled to a variable gain amplifier thereof. The temperature sensor dynamically adjusts a gain of the VGA such that adjacent channel power rejection of the RF transceiver is improved.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of system architecture of a conventional transmitter used in a communication device;

FIG. 2 is a block diagram of a communication device using an RF transceiver according to an embodiment of the invention;

FIGS. 3A˜3J are circuit diagrams of applicable embodiments of the temperature sensor 220 in FIG. 2;

FIG. 4 is an exemplary characterization diagram of the temperature sensor 220 in FIG. 2;

FIGS. 5A and 5B are respectively exemplary characterization diagrams of the IF VGA 205 in FIG. 2;

FIGS. 6A and 6B respectively show ACPR of the communication device using an RF transceiver according to an embodiment of the invention at RF frequencies of 850 MHz and 900 MHz for GSM;

FIGS. 7A and 7B respectively show RF signal power of the communication device using an RF transceiver according to an embodiment of the invention at RF frequencies of 850 MHz and 900 MHz for GSM;

FIG. 8 is a block diagram of a communication device using an RF transceiver according to another embodiment of the invention;

FIG. 9 is a block diagram of a communication device using an RF transceiver according to yet another embodiment of the invention;

FIG. 10 is a block diagram of a communication device using an RF transceiver according to another embodiment of the invention; and

FIG. 11 is a block diagram of a communication device using an RF transceiver according to another embodiment of the invention.

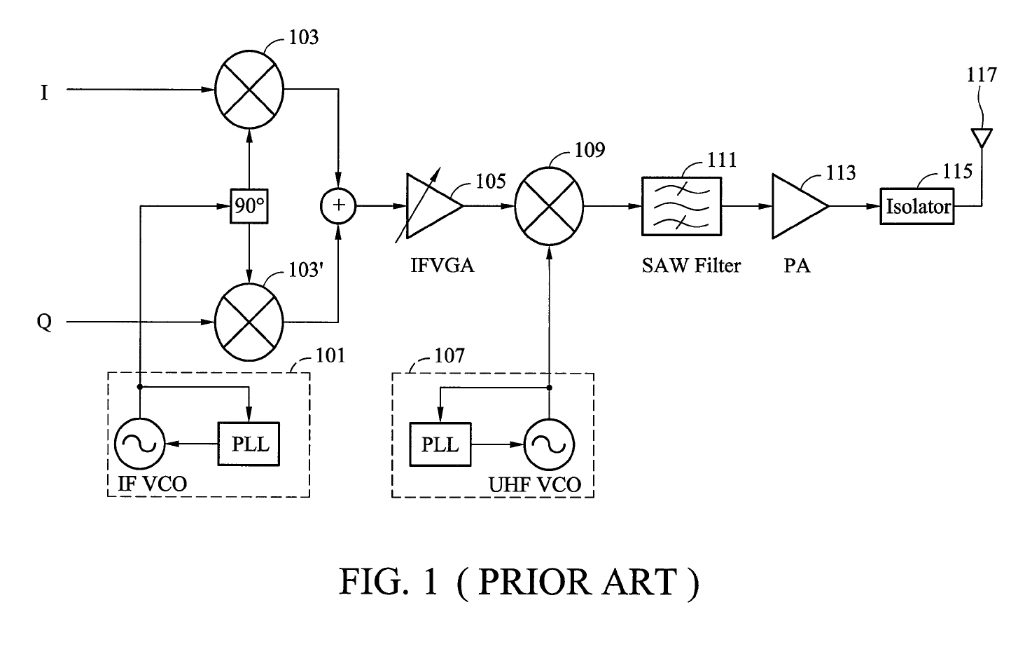

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

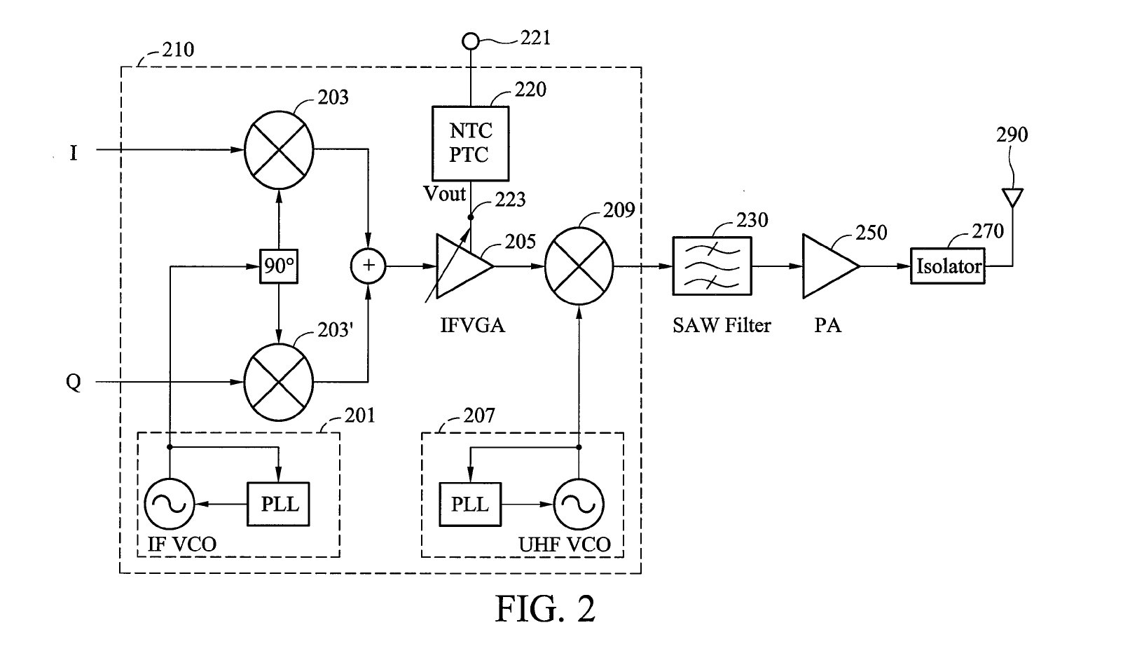

FIG. 2 is a block diagram of a communication device using an RF transceiver according to an embodiment of the invention. The communication device comprises an RF transceiver 210, a surface acoustic wave (SAW) filter 230, a power amplifier (PA) 250, an isolator 270, and an antenna 290. The transceiver 210 up-converts base band (BB) signals I and Q to a radio frequency (RF) signal. Subsequently, the RF signal is filtered by the SAW filter 230 and amplified by the power amplifier 250. The amplified RF signal is received by the isolator 115 and then transmitted by the antenna 117.

In FIG. 2, the RF transceiver comprises a first local oscillator (LO) 201, first mixers 203 and 230′, an intermediate frequency variable gain amplifier (IF VGA) 205, a second LO 207, a second mixer 209, and a temperature sensor 220. The first mixers 230 and 203′ are coupled between the first LO 201 and the IF VGA 205. The temperature sensor 220 is coupled to the IF VGA 205. The second mixer 209 is coupled between the IF VGA 205 and the SAW filter 230. The second LO 207 is coupled to the second mixer 209. Preferably, the temperature sensor 220 comprises a thermistor.

In FIG. 2, the first LO 201 provides a first local clock to the first mixers 203 and 203′ and the same up-convert base band (BB) signals I and Q to an intermediate frequency band according to the first local clock. Up-converted signals are combined as an intermediate frequency (IF) signal. The IF VGA 205 receives and amplifies the IF signal. The second mixer 209 up-converts the amplified IF signal to a radio frequency (RF) signal according to a second clock generated by the second LO 207. Subsequently, the RF signal is transmitted to the SAW filter 230 from the RF transceiver 210. The input node 221 of temperature sensor 220 receives an input voltage Vramp from a base band processor and generates an output voltage Vout at an output node 223. A gain of the IF VGA 205 is dynamically adjusted according to the output voltage Vout. When ambient temperature decreases, the output voltage Vout from the temperature sensor 220 reduces the gain of the IF VGA 205. Since the RF signal from the transceiver is reduced several dBs by the IF VGA 205, an output signal of the PA 250 is not saturated even if a gain of the PA250 increases due to low ambient temperature. As a result, information in the output signal of the PA 250 is kept intact and the communication device 200 works properly under low ambient temperature.

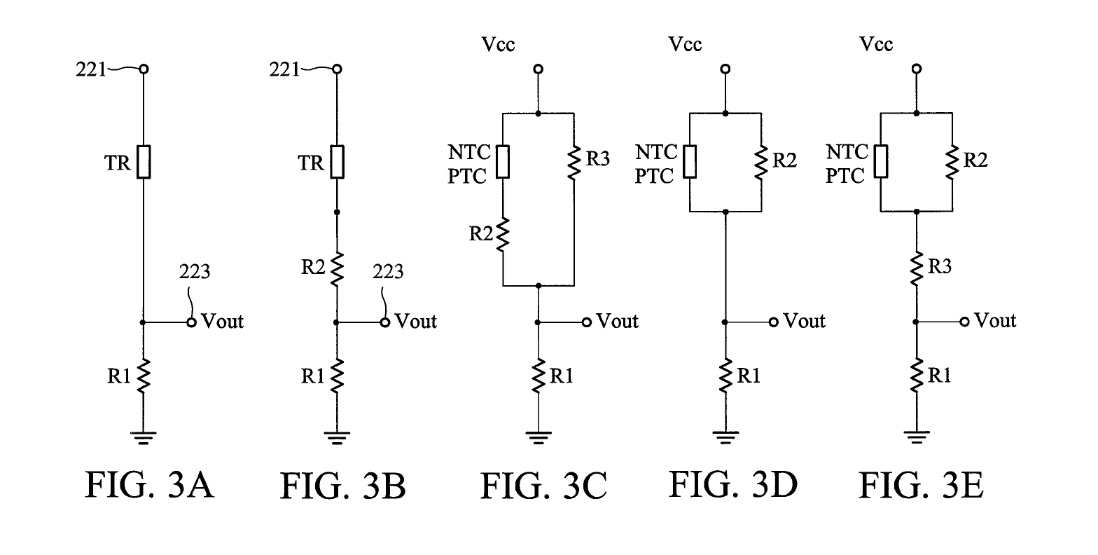

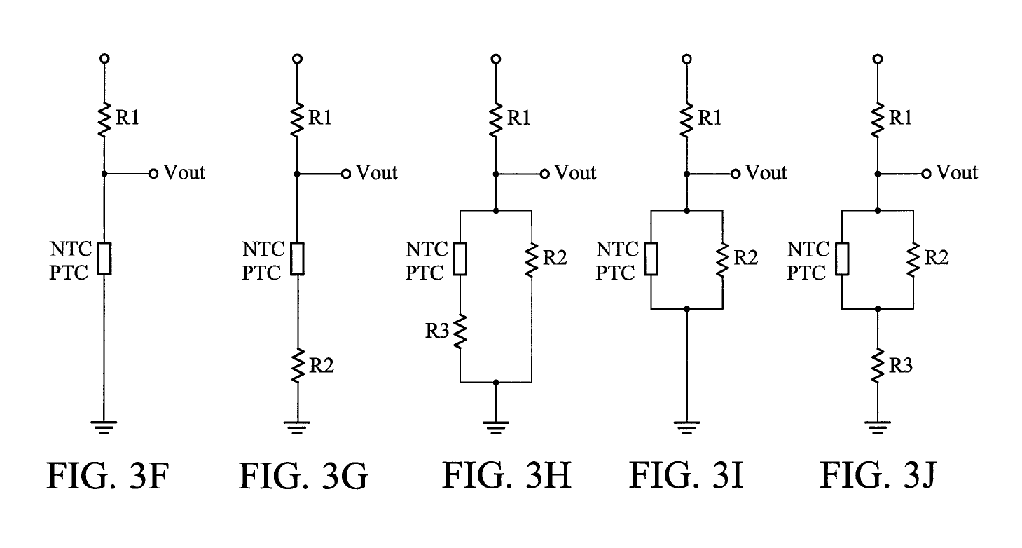

FIGS. 3A˜3J are circuit diagrams of applicable embodiments of the temperature sensor 220 in FIG. 2. In FIG. 3A, the temperature sensor comprises a first resistor R1 coupled between the output node 223 and a ground GND and a thermistor TR coupled between the input node 221 and the output node 223. In FIG. 3B, the temperature sensor is similar to that in FIG. 3A and only differs in that a second resistor R2 is coupled between the input node 221 and the output node 223 and connected in series with the thermistor TR. In FIG. 3C, the temperature sensor is similar to that in FIG. 3B and only differs in that a third resistor R3 is connected between the input node 221 and the output node 223. In FIG. 3D, the temperature sensor is similar to that in FIG. 3A and only differs in that a second resistor R2 is connected in parallel with the thermistor TR. In FIG. 3E, the temperature sensor is similar to that in FIG. 3D and only differs in that a third resistor R3 is coupled between the input node 221 and the output node 223 and connected in series with the thermistor TR along with the second resistor R2.

In FIG. 3F, the temperature sensor comprises a thermistor TR coupled between the output node 223 and a ground and a first resistor R1 coupled between the input node 221 and the output node 223. In FIG. 3G, the temperature sensor is similar to that in FIG. 3F and only differs in that a second resistor R2 is coupled between the ground and the output node 223 and connected in series with the thermistor TR. In FIG. 3H, the temperature sensor is similar to that in FIG. 3G and only differs in that a third resistor R3 is connected between the ground and the output node 223. In FIG. 3I, the temperature sensor is similar to that in FIG. 3F and only differs in that a second resistor R2 is connected in parallel with the thermistor TR. In FIG. 3J, the temperature sensor is similar to that in FIG. 3I and only differs in that a third resistor R3 is coupled between the output node 223 and the ground and connected in series with the thermistor TR along with the second resistor R2. The thermistor TR in FIGS. 3A˜3J can be thermistor with a positive temperature coefficient or a negative temperature coefficient.

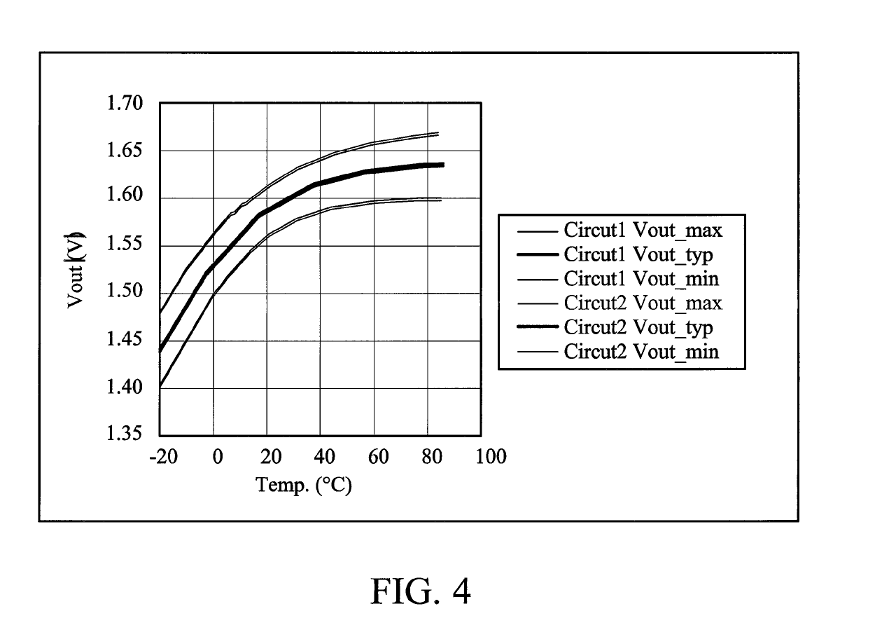

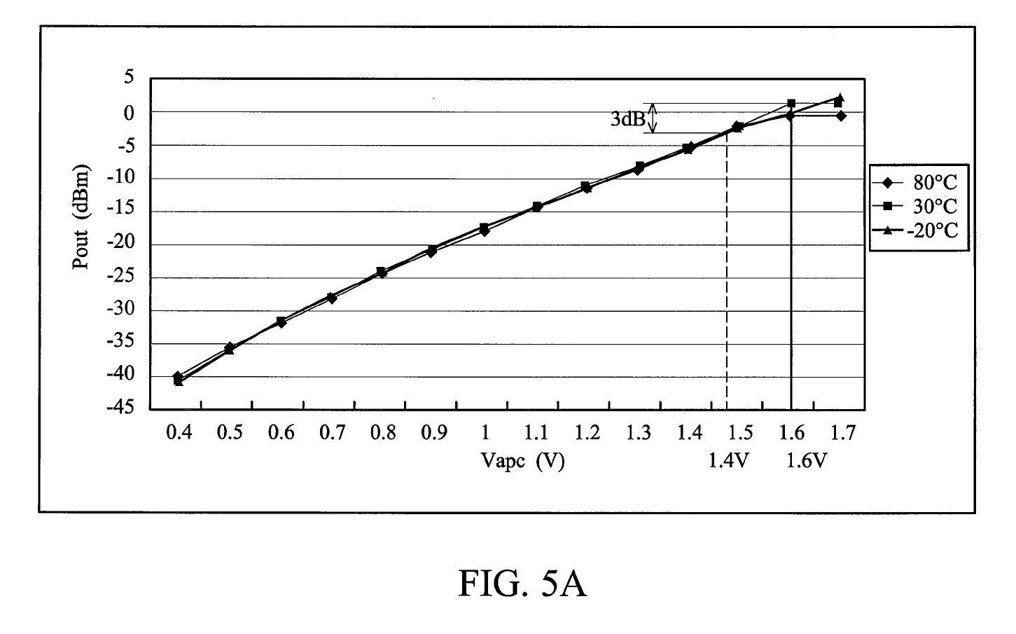

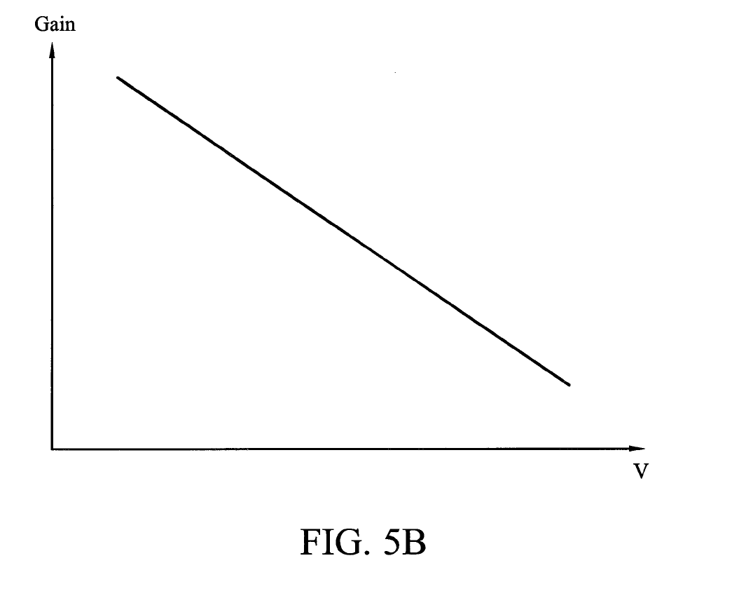

FIG. 4 is an exemplary characterization diagram of the temperature sensor 220. The output voltage Vout of the temperature sensor 220 is about 1.6V at 30° C. and 1.47V at −10° C. FIG. 5A is an exemplary characterization diagram of the IF VGA 205. In FIG. 5A, the horizontal axis is a control voltage and the vertical axis is a gain thereof. The curve in FIG. 5A has a positive slope and is impervious to temperature variation. Due to the temperature insensitivity of the IF VGA 205, a temperature compensation mechanism is added by inserting the temperature sensor 220. As shown in FIG. 5A, a decrease in the output voltage from 1.6V to 1.47V renders a decrease of 3 dB in gain of the IF VGA 205.

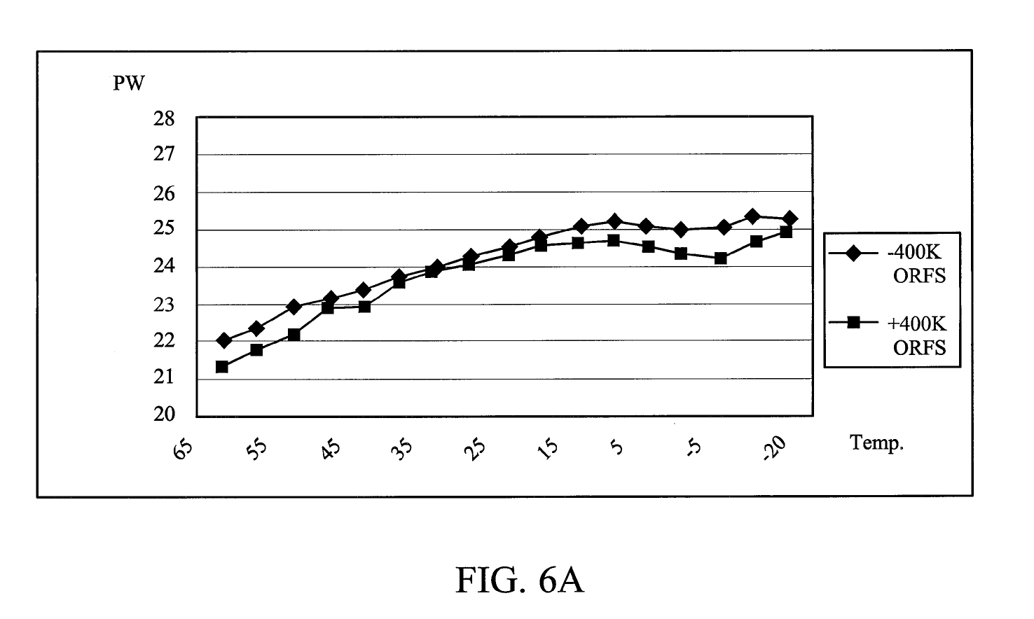

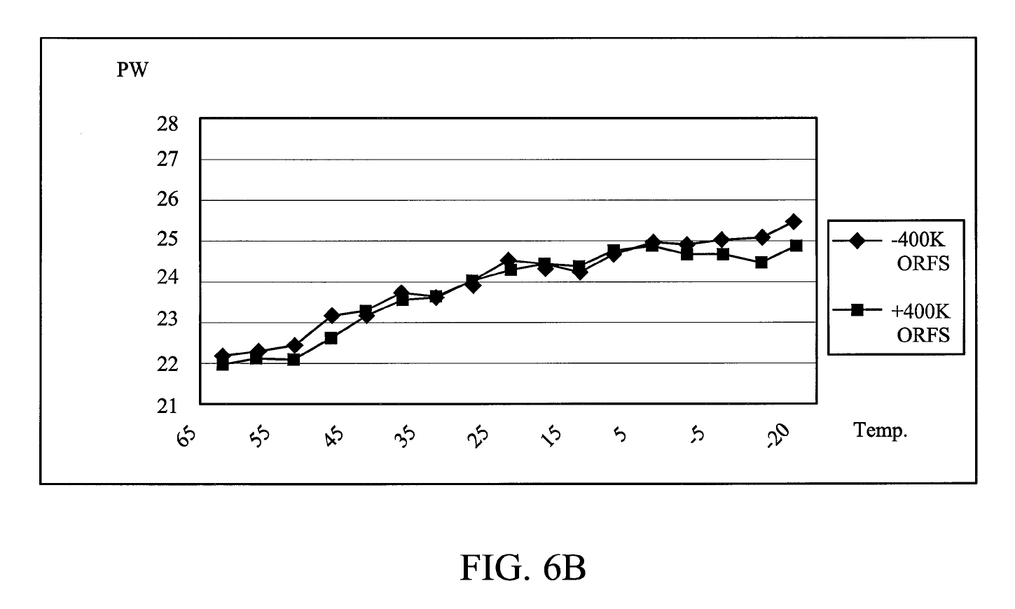

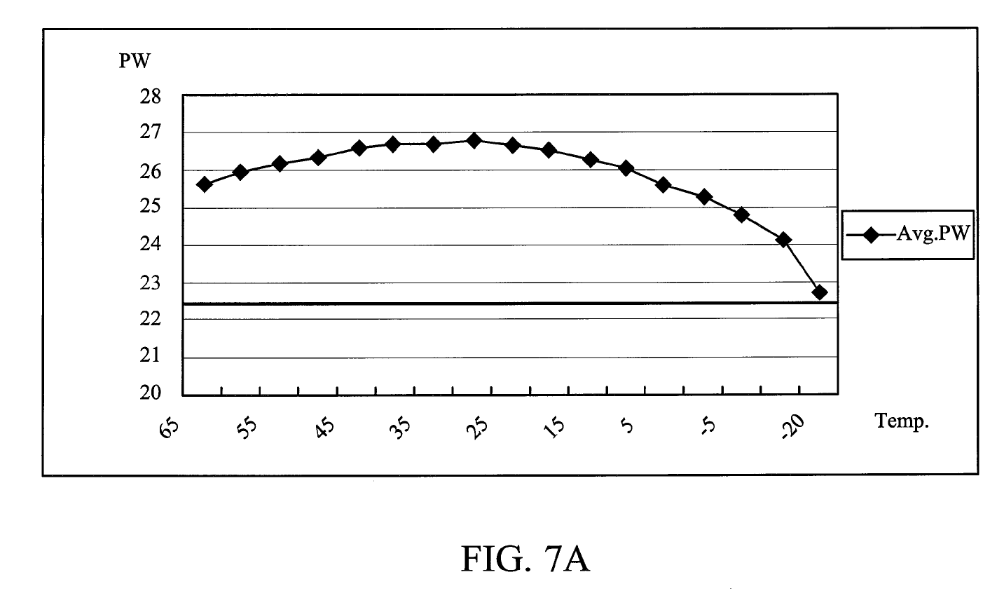

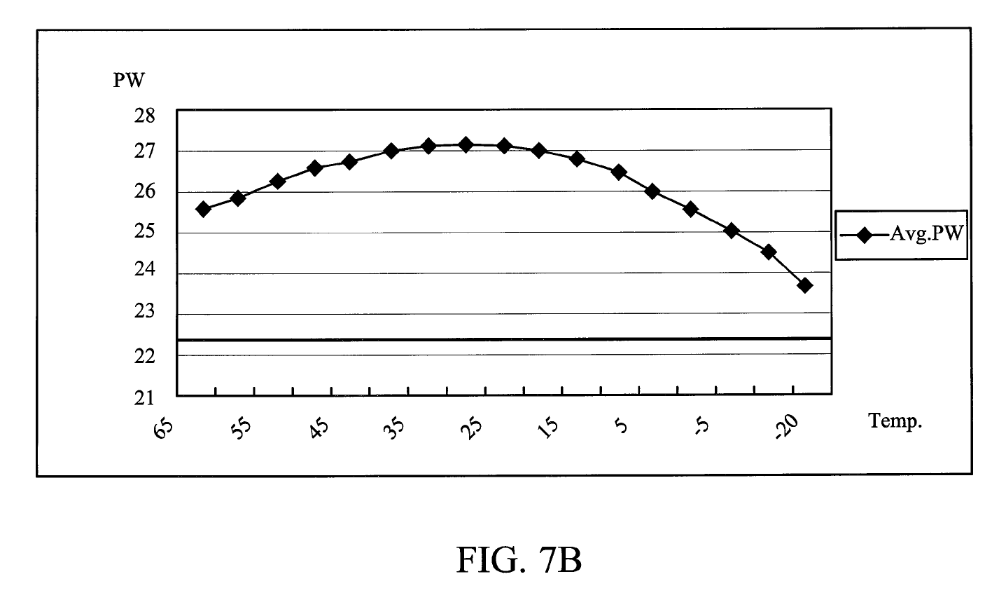

FIGS. 6A and 6B respectively show ACPR of the communication device using an RF transceiver according to an embodiment of the invention at RF frequencies of 850 MHz and 900 MHz for GSM. In FIGS. 6A and 6B, the horizontal axis is ambient temperature in ° C. and the vertical axis is ACPR in dBc. Due to the temperature sensor 220, ACPR of the communication device is significantly improved when ambient temperature is lower than 20° C. FIGS. 7A and 7B respectively show RF signal power of the communication device using an RF transceiver according to an embodiment of the invention at RF frequencies of 850 MHz and 900 MHz for GSM. In FIGS. 7A and 7B, the horizontal axis is ambient temperature in ° C. and the vertical axis is RF signal power in dBm. Due to the temperature sensor 220, RF signal power of the communication device is significantly suppressed when ambient temperature is lower than 20° C. As a result, RF signal is not saturated and the communication works properly at low ambient temperature.

It is noted that FIG. 5A is merely an exemplary characterization diagram of the IF VGA 205. FIG. 5B shows another exemplary characterization diagram of the IF VGA 205. As shown in FIG. 5B, gain of the IF VGA 205 decreases with a control voltage thereof. To add a temperature compensation mechanism to the IF VGA 205, the temperature sensors in FIGS. 3A˜3J are feasible solutions.

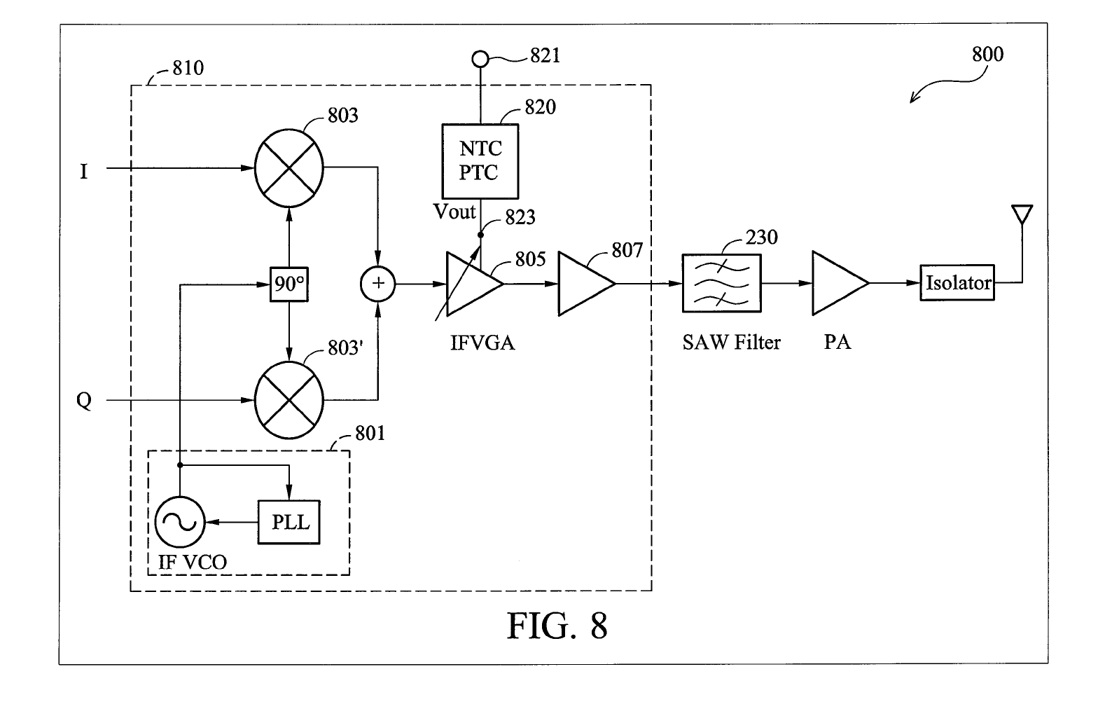

FIG. 8 is a block diagram of a communication device using an RF transceiver according to another embodiment of the invention. The communication device 800 in FIG. 8 is similar to that in FIG. 2 and only differs in the RF transceiver. The RF transceiver 810 in FIG. 8 comprises a LO 801, mixers 803 and 803′, an RF VGA 805, and a temperature sensor 820. The mixers 803 and 803′ are coupled between the LO 801 and the RF VGA 805. The temperature sensor 820 is coupled to the RF VGA 805. In addition, the RF transceiver 810 can further comprise a RF buffer 807 coupled between the RF VGA 805 and the SAW filter 230. The LO 801 provides a local clock to the mixers 803 and 803′ and the same up-convert base band (BB) signals I and Q directly to a radio frequency band according to the local clock. Up-converted signals are combined as a radio frequency (RF) signal. The RF VGA 805 receives and amplifies the RF signal. Subsequently, the amplified RF signal is transmitted to the SAW filter 830 (via the RF buffer 807) from the RF transceiver 810. The input node 821 of temperature sensor 820 receives an input voltage Vramp from a base band processor and generates an output voltage Vout at an output node 823. A gain of the RF VGA 805 is dynamically adjusted according to the output voltage Vout. It is noted that the temperature sensors shown in FIG. 3A˜3J are applicable to the RF transceiver 810 in FIG. 8.

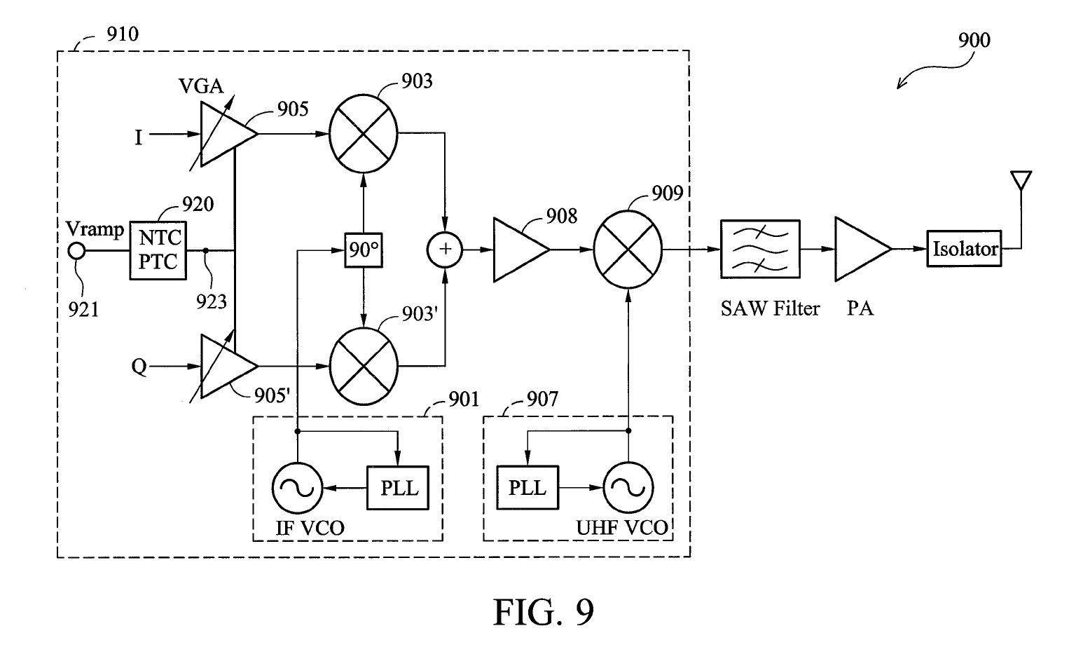

FIG. 9 is a block diagram of a communication device using an RF transceiver according to yet another embodiment of the invention. The communication device 900 in FIG. 9 is similar to that in FIG. 2 and only differs in the RF transceiver. The RF transceiver 910 in FIG. 9 comprises a LO 901, first mixers 903 and 903′, base band (BB) VGAs 905 and 905′, a second local oscillator 908, a second mixer 909 and a temperature sensor 920. The mixers 903 and 903′ are coupled between the LO 901 and the second mixer 909. The BB VGAs 905 and 905′ are respectively coupled to the first mixers 903 and 903′. The temperature sensor 820 is coupled to the BB VGAs 905 and 905′. A second LO 907 is coupled to the second mixer 909. In addition, the RF transceiver 910 can further comprise an IF buffer 907 coupled between the first mixers 903 and 903′ and the second mixer 909. The BB VGAs 905 and 905′ respectively receive and amplify base band signals I and Q. The mixers respectively up-convert the amplified base band signals I and Q to an IF band according to the first local clock generated by the first LO 901. Up-converted signals are combined as an intermediate frequency (IF) signal. The second mixer 209 receives and up-converts the IF signal to a radio frequency (RF) signal according to a second clock generated by the second LO 907. Subsequently, the RF signal is transmitted to the SAW filter 230 from the RF transceiver 910. The input node 921 of temperature sensor 920 receives an input voltage Vramp from a base band processor and generates an output voltage Vout at an output node 923. A gain of the IF VGA 905 is dynamically adjusted according to the output voltage Vout. It is noted that the temperature sensors shown in FIG. 3A˜3J are applicable to the RF transceiver 910 in FIG. 9.

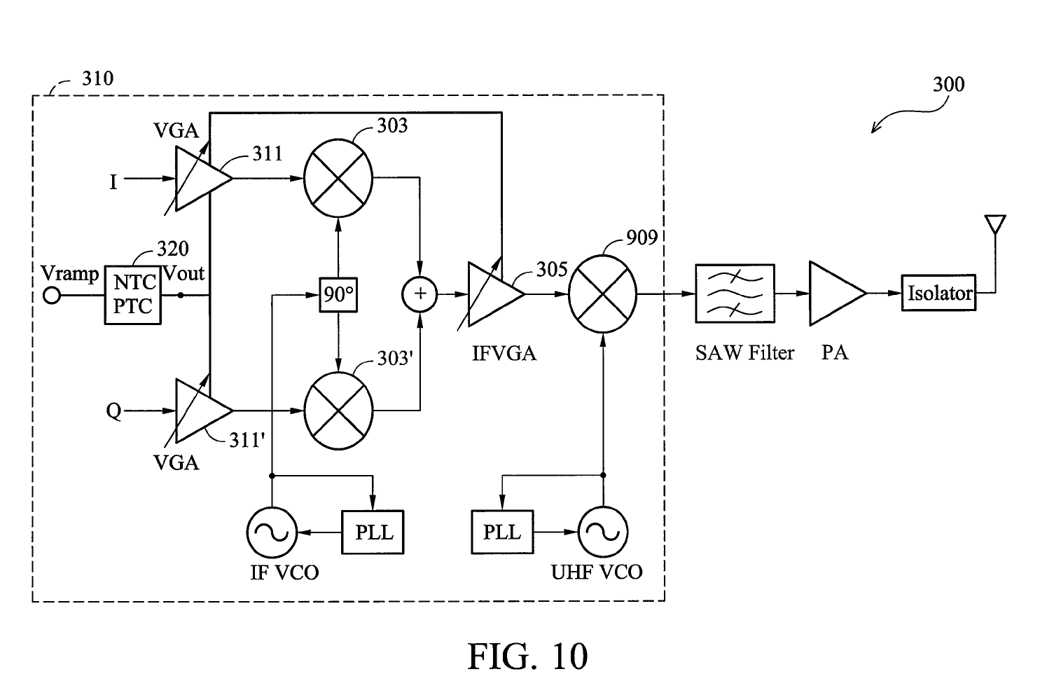

FIG. 10 is a block diagram of a communication device using an RF transceiver according to another embodiment of the invention. The communication device 300 in FIG. 10 is similar to that in FIG. 2 and only differs in that the RF transceiver 310 in FIG. 10 further comprises BB VGAs 311 and 311′ respectively coupled to the first mixers 303 and 303′ and the temperature sensor 320 is coupled to the BB VGAs 311 and 311′ and the IF VGA 305. The BB VGAs 311 and 311′ respectively receive and amplify the BB signals I and Q. The amplified BB signals are respectively transmitted to the first mixers 303 and 303′ for subsequent process. Gain of the BB VGAs 311 and 311′ and the IF VGA 305 are dynamically adjusted according to the output voltage Vout. It is noted that the temperature sensors shown in FIG. 3A˜3J are applicable to the RF transceiver 310 in FIG. 10.

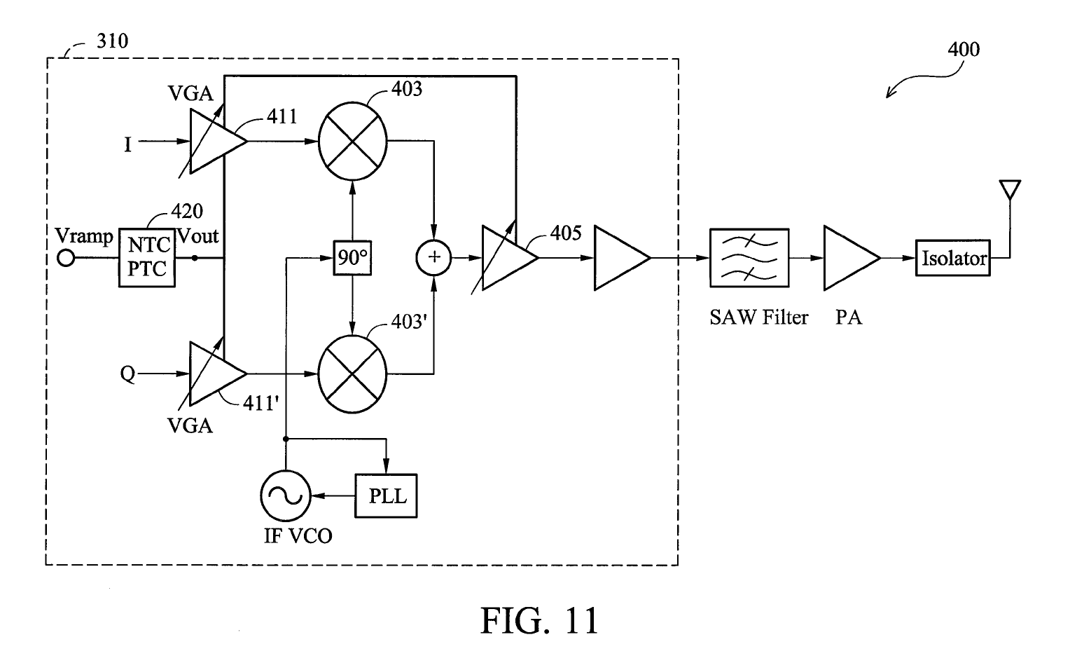

FIG. 11 is a block diagram of a communication device using an RF transceiver according to another embodiment of the invention. The communication device 400 in FIG. 11 is similar to that in FIG. 3 and only differs in that the RF transceiver 410 in FIG. 11 further comprises BB VGAs 411 and 411′ respectively coupled to the first mixers 403 and 403′ and the temperature sensor 420 is coupled to the BB VGAs 411 and 411′ and the RF VGA 405. The BB VGAs 411 and 411′ respectively receive and amplify the BB signals I and Q. The amplified BB signals are respectively transmitted to the first mixers 403 and 403′ for subsequent process. Gain of the BB VGAs 411 and 411′ and the RF VGA 405 are dynamically adjusted according to the output voltage Vout. It is noted that the temperature sensors shown in FIG. 3A˜3J are applicable to the RF transceiver 410 in FIG. 11.

While the invention has been described by way of example and in terms of preferred embodiment, it is to be understood that the invention is not limited thereto. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An RF transceiver, comprising:
a temperature control circuit, having a thermistor, for receiving an input voltage at an input node and outputting an output voltage at an output node; and
a first variable gain amplifier (VGA) coupled to the output node of the temperature control circuit, wherein a gain of the first VGA is controlled by the output voltage.

2. The RF transceiver as claimed in claim 1, wherein the temperature control circuit comprises a NTC thermistor.

3. The RF transceiver as claimed in claim 1, wherein the first VGA is an intermediate frequency (IF) VGA.

4. The RF transceiver as claimed in claim 1, wherein the first VGA is a radio frequency (RF) VGA.

5. The RF transceiver as claimed in claim 1, further comprising a second VGA coupled to the temperature control circuit wherein a gain of the second VGA is controlled by the output voltage.

6. The RF transceiver as claimed in claim 6, wherein the first and second VGAs are base band VGAs.

7. The RF transceiver as claimed in claim 5, further comprising a third VGA coupled to the temperature control circuit, wherein a gain of the third VGA is controlled by the output voltage.

8. The RF transceiver as claimed in claim 7, wherein the third VGA is an intermediate frequency (IF) VGA.

9. The RF transceiver as claimed in claim 7, wherein the third VGA is a radio frequency (RF) VGA.

10. The RF transceiver as claimed in claim 1, wherein the temperature control circuit further comprises a first resistor coupled between the output node and a ground with the thermistor coupled between the input node and the output node.

11. The RF transceiver as claimed in claim 10, wherein the temperature control circuit further comprises a second resistor coupled between the input node and the output node, and connected in series with the thermistor.

12. The RF transceiver as claimed in claim 11, wherein the temperature control circuit further comprises a third resistor connected between the input node and the output node.

13. The RF transceiver as claimed in claim 10, wherein the temperature control circuit further comprises a second resistor connected in parallel with the thermistor.

14. The RF transceiver as claimed in claim 13, wherein the temperature control circuit further comprises a third resistor coupled between the input node and the output node, and connected in series with the thermistor along with the second resistor.

15. The RF transceiver as claimed in claim 1, wherein the temperature control circuit further comprises a first resistor coupled between the input node and the output node with the thermistor coupled between the output node and a ground.

16. The RF transceiver as claimed in claim 15, wherein the temperature control circuit further comprises a second resistor coupled between the ground and the output node, and connected in series with the thermistor.

17. The RF transceiver as claimed in claim 16, wherein the temperature control circuit further comprises a third resistor connected between the ground and the output node.

18. The RF transceiver as claimed in claim 15, wherein the temperature control circuit further comprises a second resistor connected in parallel with the thermistor.

19. The RF transceiver as claimed in claim 18, wherein the temperature control circuit further comprises a third resistor coupled between the output node and the ground, and connected in series with the thermistor along with the second resistor.

20. A communication system comprising the RF transceiver as claimed in claim 1, and a power amplifier coupled thereto.
